(19) United States
(12) Patent Application Publication
(10) Pub. No.: US 2012/0151978 A1
(43) Pub. Date: Jun. 21, 2012

(54) Platform Mill for Producing Helically Wound Pipe and Related Method

(76) Inventors: William L. Zepp, Maineville, OH (US); Daniel W. Aberle, Portland, OR (US); Darrell J. Sanders, Mason, OH (US); Mark A. Dawson, Huber Heights, OH (US)

(21) Appl. No.: 13/312,367

(22) Filed: Dec. 6, 2011

Related U.S. Application Data
(60) Provisional application No. 61/424,419, filed on Dec. 17, 2010.

(51) Int. Cl. B21C 37/12; B23K 26/00; B23Q 16/00; B21C 51/00; B21C 37/08

(52) U.S. Cl. 72/6.1; 72/49; 219/121.63

(57) ABSTRACT

A pipe production system includes a plurality of platform segments that are coupled together at a construction site to form a work platform. A helical pipe production system is mounted on the work platform. The work platform includes an integrated drive system that enables the platform to be moved around the terrain of the construction site so that pipe can be produced in-line with an intended or desire pipe laying path.

### CROSS-REFERENCES

This application claims the benefit of provisional application Ser. No. 61/424,419, filed on Dec. 17, 2010, the entirety of which is incorporated herein by reference.

### TECHNICAL FIELD

This application relates generally to apparatus for producing helically wound pipe and, more specifically, to a platform mill structure for effectively producing such pipe in an environment requiring that the mill structure be repeatedly moved at a construction site.

### BACKGROUND

The standard production process for producing helically corrugated metal pipe is well known and involves first forming lengthwise corrugations in an elongated strip of sheet metal, with the corrugations extending along the length of the strip. The corrugated strip is then spiraled into a helical form so that opposite edges of the corrugated strip come together and can either be crimped or welded to form a helical lock along the pipe. Some helically wound pipe is formed without corrugations, and plastic pipe can also be produced using a helical forming process. Platform mills for producing these pipe types can also be produced in accordance with the teachings of U.S. Pat. No. 7,404,308, which describes a system and related tooling for producing helically corrugated metal pipe, and is incorporated herein by reference. Some platform mills may also be mobile.

U.S. Pat. No. 6,000,261 (the “'261 Patent”) discloses a machine for spirally forming pipes that is transportable to various locations. The machine is mounted to the surface of a conventional tractor-trailer arrangement. Specifically the '261 Patent discloses an uncoiler assembly, to support a coil, an assembly of rollers to the sheet of uncoiled material into the spiral forming assembly for forming the pipe, and support stands to support the formed pipe. An internal combustion engine is mounted to the surface of the tractor-trailer arrangement to provide rotational energy to the assembly of rollers. The mounted internal combustion engine is rotationally coupled to the roller assembly gearbox. The engine also provides rotational energy to other support apparatus via belts and pulleys. The support apparatus includes a hydraulic pump, air compressor, and generator.

The apparatus disclosed in the '261 Patent has several limitations. First, by utilizing a standard tractor-trailer arrangement there is a limitation to the amount of items that can be mounted to it. For example, the '261 Patent does not show the support apparatus mounted to the surface of the trailer, and it is unclear whether the support apparatus are mounted to the trailer or located elsewhere. Another limitation cause by the trailer's space constraints is that there is no room on the trailer to support the pipe as it is produced. This requires the immediate coordination and alignment of multiple separate pipe stands, which will increase the difficulty of producing long continuous lengths of pipes. Given the tight space constraints of the tractor-trailer arrangement, operator safety is a concern. Finally, a standard tractor-trailer arrangement is limited to where it can drive. Roads or paths must first be built at the construction site in order to transport the apparatus to the desired location. The device of the '261 Patent enables pipe to be produced at the site where the pipe will be installed, but does not facilitate pipe production immediately adjacent the location where the pipe will be laid for installation.

U.S. Pat. No. 7,117,702 (the “'702 Patent”) discloses a portable apparatus for forming pipe from helical convulsions of elongated sheet metal. The machine is mounted to the surface of a trailer, which may be pulled by a suitable truck in a conventional fashion. Specifically, the '702 Patent discloses an a decoiler, rolling portion, forming head, cutoff saw, and dump table. The '702 Patent discloses that the cutoff saw, and dump table are mounted on a rigid frame, which may pivot relative to the trailer. The functions of the portable apparatus are preferably controlled by a PLC controller. The '702 Patent does not disclose how power is being provided to the controller or motors. Additionally, supporting apparatus such as air compressors, generators, and/or hydraulic pumps are not disclosed. In practice, a system similar to that of the '702 Patent was implemented using a second trailer that carried a diesel generator set, air compressor and water tanks to the job site.

The apparatus disclosed in the '702 Patent has many of the same limitations disclosed in the '261 Patent. The apparatus is limited to the space constraints of a trailer, which does not have the space to mount all of the necessary support machines. The '702 Patent does not disclose supporting a pipe with a length greater than the length of the dump table. Therefore, the apparatus disclosed in the '702 Patent is limited in the length of pipe that may be produced. Finally, using a truck in a conventional fashion to move the apparatus limits the terrain types where the apparatus may be used and does not facilitate pipe production immediately adjacent the location where the pipe will be laid for installation.

Other issues present in the prior art systems include the fact that when moving the machinery the pipe production line must be broken down and then set back up in the new location. set up is sustained in the invention rather than having to break down and set back up. Pipe length limitations also exist because the prior art systems only push the pipe through the forming head.

### SUMMARY

This application is directed to a mobile platform mill for on-site production of pipe. The mobile platform mill includes a plurality of platform segments coupled together on-site to form a work platform, a driver unit supporting the work platform above the ground and adapted to move the work platform about the rugged terrain of a construction site, and a pipe production system mounted on the work platform.

In one aspect, a mobile platform mill for on-site production of pipe includes:a plurality of platform segments coupled together to form a work platform; a driver unit supporting the work platform above the ground and adapted to move the work platform about a construction site; a pipe production system mounted on the work platform and including: (i) a decoiler unit for holding and decoiling a rolled steel sheet, (ii) a profiling mill for forming said steel sheet into a desired profile, (iii) a forming mill for helically coiling said profiled steel sheet into a pipe form, (iv) a joiner unit (which in one embodiment may be a welding apparatus) for joining a helical seam of said pipe form, (v) a generator to provide power to said mobile platform mill and (vi) a controller for controlling operations of said mobile platform mill.

In one embodiment of the mobile platform mill of the preceding paragraph, the mill includes a leveling system on the work platform for leveling said work platform.

In one embodiment of the mobile platform mill of either of the two preceding paragraphs, the mill includes a pipe pull arrangement that pulls said pipe form from said forming mill. In one implementation the pipe puller includes a pull drive motor and a plurality of driven rubber wheels, where the driven rubber wheels may be angled relative to a longitudinal axis of the pipe form to align with a helix angle of the helical seam the pipe form.

In one embodiment of the mobile platform mill of any of the three preceding paragraphs, the driver unit further includes a series of drive tracks, and the mill may further include at least one of (i) a global positioning system (GPS) adapted to assist in positioning the work platform for pipe production or (ii) a laser sighting system.

In one embodiment of the mill of any of the four preceding paragraphs, the leveling system includes a plurality of powered actuators with leveling sensors providing feedback control.

The mobile platform mill of any of the five preceding paragraphs may be used in combination with a pipe pull system that includes (i) a pipe pull cone apparatus for connecting to the exiting end of said pipe form, (ii) a pipe pull winch and (iii) a cable for connecting said pipe pull cone to said pipe pull winch. The pipe pull winch may be mounted on a vehicle that is movable separate from the platform mill.

The combination of the mobile platform mill and the pipe pull system may further include a laser sighting and alignment apparatus adapted to assure the desired and appropriate alignment of said mobile platform mill and said pipe pull winch prior to pipe production.

In one embodiment of the mill of any f the seven preceding paragraphs, the mill includes a railing along side edge portions of the work platform, and a tent structure to substantially enclose a working space above the work platform. In one implementation one or more heater units may be provided to heat the space inside the tent.

In one embodiment of the mobile platform mill of any of the eight preceding paragraphs, the mill includes an inspection station for inspecting said joined helical seam, a compressed air system to provide air pressure to said mobile platform mill and a cutoff unit for cutting of said pipe form to a desired length.

In the mobile platform mill of any of the nine preceding paragraphs each of the platform segments is sized for transport on standard size truck trailer.

In another aspect, a method for on-site production of pipe using a mobile platform mill and a mobile pipe puller involves: utilizing a mobile platform mill that includes a platform formed of a plurality of platform segments assembled on-site and supporting a corrugated metal pipe production system that includes a profiling mill for forming said steel sheet into a desired profile, a forming mill for helically coiling said profiled steel sheet into a pipe form, and a joiner unit for joining a helical seam of said pipe form, the mobile platform mill further comprising an on-board platform drive system for moving the platform around the job site independent of any transport truck or vehicle; utilizing a mobile pipe pull apparatus that is separate from the mobile platform mill and includes a pipe pull cable and winch; positioning the mobile platform mill toward a first end of a defined pipe laying path by operation of the on-board platform drive system; positioning the mobile pipe pull apparatus toward a second end of the defined pipe laying path; operating the pipe production system of the mobile platform mill to produce corrugated metal pipe; operatively coupling the pipe pull cable to the corrugated metal pipe; and operating the pipe pull winch to pull pipe along the pipe laying path as it is produced.

### BRIEF DESCRIPTION OF THE DRAWINGS

FIG. 1 is a perspective view of one embodiment of a mobile platform mill;

FIG. 2 is a top view of one embodiment of a mobile platform mill;

FIG. 3 is a side view of one embodiment of a mobile platform mill;

FIG. 4 illustrates an exemplary mobile platform mill working in conjunction with an exemplary pipe pull system.

### DETAILED DESCRIPTION

A spiral mill and all other required processes are incorporated on a large steel structure platform that includes all support utilities (self contained mobile platform mill). This platform structure is capable of maneuvering by itself on a project site from one location to another location without any other support to move the platform.

The platform structure will be designed in modular sections (e.g., 5-10 planks on the order of about 8′ to 10′ by about 40′) that can be shipped from one project site location to another project site via normal shipping methods without any special shipping permits. Once all of the platform structure components have been shipped and delivered to the project site, the work platform is erected, to include all production processes and support utilities installed on the platform.

The mobile platform mill will have the production capability to produce pipe lengths of 1200 foot. The length capability can be great than 1200 foot if additional pipe drive units are fitted. The diameter range is for production of pipe from 12 inch to 192 inches in diameter (e.g., with pipe diameter being varied by suitable angular positioning of the pipe mill body to the pipe mill head). This may be achieved by incorporating and coordinating (3) drive units (a mill drive motor, a pull drive motor & a winch drive motor) through electronics (PLC). The mill drive motor (e.g., motor 28 in U.S. Pat. No. 7,404,308) drives all the mill gearboxes (e.g., arrangement 30 in U.S. Pat. No. 7,404,308) on the mill to form the desired corrugation through the mill head. The pull drive motor is located after the mill head on the pipe run-out table and incorporated in a system to grip the pipe and provide a rotational pull of the pipe from the head. For example, a plurality of wide rubber wheels that capture the outside diameter of the pipe and act to pull the pipe out of the mill head. The winch drive motor is located at the end of desired length of pipe and may be mounted on a vehicle, preferably a drone vehicle. The winch cable is extended back to the platform mill and connected to the leading edge of the pipe to be produced. It also provides a pulling function. All (3) of these drive motor speeds are, in one embodiment, coordinated through a PLC in conjunction with an encoder system that measures actual coil steel feed speed and pipe rotation speed, to overcome unknown slippage that is common in spiral mill applications.

The provision of a mill that provides for both a push operation into the mill head and a pull operation out of the mill head, facilitates long pipe product runs. On long runs of pipe a series of spaced apart pipe support sleds with cradled rollers may be located along the pipe pull line (e.g., spaced apart every 40 to 60 feet) to reduce resistance loading and to keep the pipe on appropriate line. In order to keep the pipe stable and prevent the pipe from jumping the helical seam or lock, the mill includes alignment hold down reports (e.g., such as chain roller supports) to ensure pipe sustains constant stabilization until leaving the platform.

The mobile platform mill may utilize a laser welding apparatus, or other suitable welding apparatus, such as induction welding apparatus, to produce a welded seam to achieve water tight pipe specifications of 10.5 psi. This mill process may also have constant 100% monitoring and verification capability of the welded lock seam to ensure compliance. The monitoring and verification can implemented by numerous methods, including x-ray, heat monitoring or visual inspection.

Once the platform mill has been assembled on site to include all processes and support utilities, the mill is setup to desired corrugation and diameter. The seam is constantly welded and inspected to ensure water tightness specification. Once the pipe leading edge reaches end of run-out pipe roller transfer system, the winch cone is installed to ensure that during the pipe production process that the pipe speed stays constant until length of pipe desired is achieved, so as to avoid overloading the electrical source. Once the length if pipe is achieved, the pipe is either saw or plasma cut by suitable apparatus on the platform, and the pipe laid down. The mill is stopped to relocate the entire platform to next site location that pipe is required. For this purpose, the mill includes a set of distributed tractor units, or alternatively wheel units, that can be operated to move the platform without taking the platform apart or disrupting the set-up of the pipe production line on the platform. The tractor units are connected to a common control to assure independently controlled but coordinated movement (including synchronous movement) and enable turning of the platform as necessary. Once the entire platform is relocated to it next point of pipe being required, the winch cone is installed and the mill re-started to produce desired pipe. This production process is simple as a light switch; there is not any re-adjustment or setup between lengths of pipe, just the function of moving the work platform from one pipe laying path to the next.

The platform pill may use a series of Caterpillar style drive tracks that are capable of performing on any type of construction site conditions. A GPS System may be provided to assist in moving the mill from point to point with precision to ensure pipe is produced and laid to the customer's expectation. The GPS system may also be utilized to assist in steering the platform from point to point on the project site. Each Caterpillar style drive tracks may also have and independently controlled leveling system, with coordination between the multiple leveling systems, to ensure the platform is always level to sustain a repeatable pipe process. Once the unit is in position for the a given pipe run, a leveling routine is run and the platform is automatically leveled via powered actuators, with leveling sensors providing feedback control. Alternatively, a mechanical leveling system (e.g., a plurality of mechanical jacks mounted in a distribute manner about the work platform) could be provided for manual leveling.

The platform mill may also allow for quick disconnect of the mill body so that it can be re-located on another part of the platform to produce infinite lengths of corrugated sheet material of in customer specification.

In one embodiment, the platform mill process components include: a decoiler for holding rolled steel sheet; a manual sheet splice weld station between the decoiler and the forming mill; a forming mill (e.g., a corrugating line) for working the metal sheet to desired profile, a mill for helically coiling the profiled metal sheet, a laser (or other) welder for welding the helical seam, a constant weld inspection apparatus, a pipe puller mounted on the platform, a run-out pipe transfer apparatus, a pipe stabilizer chain roller system, a pipe cut to length plasma (or other) cut-off saw, a generator for producing power for all apparatus, a compressed air system, a water recovery system for forming coolant, a pipe pull cone for connection to the exiting end of pipe, a pipe pull winch connected to the cone via a cable or chain, pipe roller sleds, a Caterpillar track steering & drive system for platform mobility, a GPS system and/or laser sighting system for accurate pipe laying alignment accuracy and a platform leveling system.

In one implementation, the mobile pipe mill is used to lay side by side pipe lengths in a hydrocarbon recovery system such as that described in U.S. Patent Publication No. 2008/0190813, with the platform mill located at one end of the capsule being formed and the pull winch drive located at the opposite end of the capsule being formed. The platform mill and pull winch drive units may include laser sighting and alignment apparatus to assure desired and appropriate alignment of the two units prior to pipe production.

The methodology involves, transporting a plurality of structural platform segments or modules to a pipe installation site, assembling the platform segments or modules on-site to form a platform mill that includes a decoiler for holding coiled steel sheet, a corrugating line for forming the coiled steel sheet into a corrugated steel sheet, a pipe mill head for helically winding the corrugated steel sheet into a pipe form, a welding unit for welding a helically seam of the pipe form, a cutoff unit for cutting the pipe form into desired lengths, a plurality of track-style units supporting the platform structure to facilitate movement of the platform structure, a leveling system and a generator unit for providing power to the equipment on the platform unit.

Once assembled, the platform mill is moved via operation of the track-style units into a desired position to produce pipe and the leveling system used to level the platform. The mill is operated to produce pipe and the pipe runs off of the platform structure in the direction desired for pipe placement and substantially along the pipe laying path. Pipe drive and support equipment on the platform mill downstream of the welding unit, in combination with a pipe pulling unit (e.g., winch drive spaced from the platform mill) coupled with winch cable and pipe cone, can be used to support and pull the pipe to desired position. Once the desired length of pipe is achieved, the pipe is cut and laid in place. The platform mill is then moved to a next pipe production location (e.g., to a next pipe laying path via operation of the track-style units, which may be in combination with GPS), the platform again leveled, the winch drive also moved to its new location and pipe cone reconnected to the end of the pipe and pipe production repeated.

The platform mill may include a composite tent structure to cover and enclose the mill apparatus and the mill operators, to facilitate maintenance of lower temperatures in the summer and warmer temperatures in the winter. In this regard; one or more heater units may be provided on the platform mill in the enclosure to facilitate operation in colder climates.

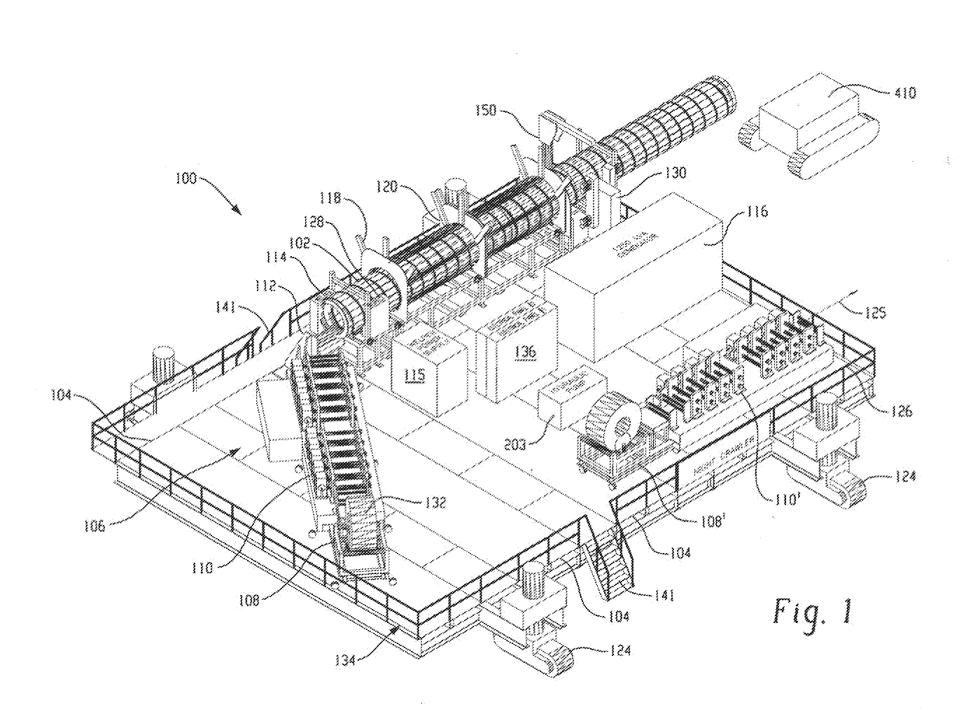

Referring now to FIG. 1, an exemplary mobile platform mill 100 supported by drive tracks 124 is shown. The mobile platform mill 100 includes a plurality of platform segments 104, which are coupled together to form a work platform 134 and a pipe production system 106 mounted on the work platform 134. In an embodiment, the platform segments 104 are sized for transport on a standard size truck trailer and are formed of a top metal plate structure and underlying steal beams (e.g., 1-beams) to provide structural support. Edge located support beams of each platform segment may include openings positioned for alignment with similar openings of the adjacent platform segment so that the multiple segments can be bolted together into a single rigid platform.

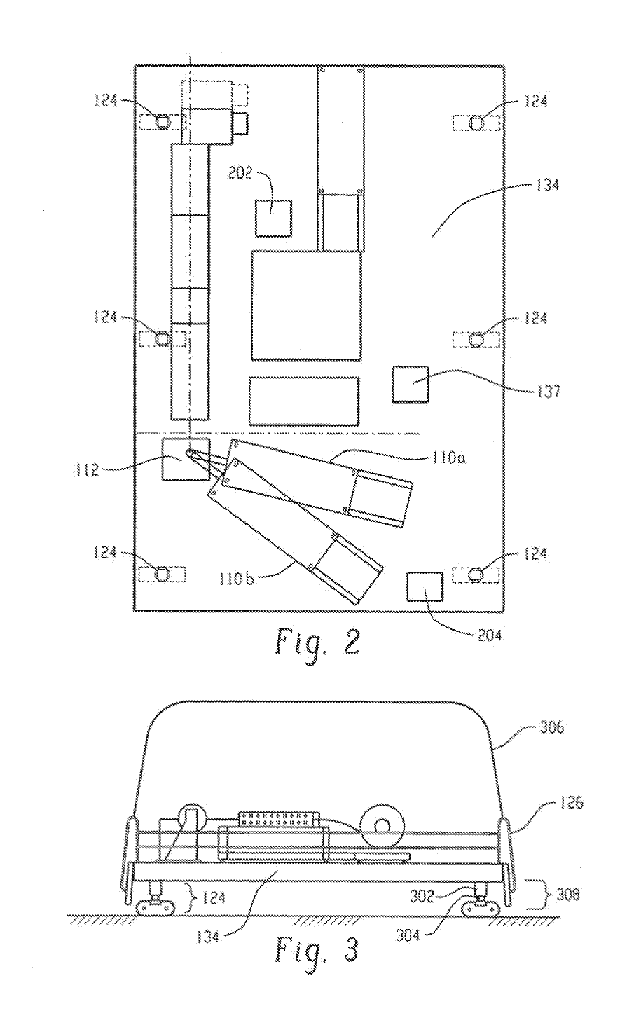

The work platform 134 is supported above the ground by a drive unit made up of the multiple track members 124, which is adapted to move'the work platform 134 about the rugged terrain of a construction site. In an embodiment, the driver unit includes a plurality of Caterpillar style drive tracks capable of traversing terrain that would be impassible to vehicles with conventional wheels, with each drive track controllable independently of the others, by a control system 137 (FIG. 2) that coordinates the operation of the multiple tracks to achieve desired motion of the work platform.

In an embodiment the pipe production system 106 mounted on the work platform 134 includes: a decoiler unit 108 for holding and decoiling a rolled steel sheet 132; a profiling mill 110 for forming the steel sheet 132 into a desired profile; a forming mill 112 for helically coiling the profiled steel sheet into a pipe form 102; a joiner unit 114 (e.g., a welder) for joining the helical seam of the pipe form 102; a generator 116 (and associated electrical distribution system 136) that provides power to the mobile platform mill 100, and a controller 137 (FIG. 2) for controlling the operations of the mobile platform mill 100. The pipe production system 106 may also include a pipe puller 118, a pipe stabilizer unit 120, an inspection station 128, and a cutoff unit 130.

In an embodiment, during pipe production a rolled steel sheet 132 is placed on the decoiler unit 108. The decoiler unit 108 unrolls the steel and feeds the steel into the profiling mill 110. The steel then passes through the profiling mill 110, which includes a set of rollers that form the steel sheet into a desired profile. Upon exiting the profiling mill 110, the steel enters the forming mill 112. The forming mill 112 helically coils the profiled steel to produce a pipe form 102. During the helical coiling process the edges of the steel either abut or interlock depending on the desired joint configuration to form a helical seam. As the helical coil of steel is pushed out of the forming mill 112, a joiner unit 114 joins the helical seam of the pipe form 102. in an embodiment, the joiner unit 114 is a laser welding apparatus with associated welding power supply 115. The laser welding apparatus is exemplary, and persons of ordinary skill in the art will recognize that there are other suitable welding apparatus and/or crimping means that may be used to join the helical seam. After the helical seam is joined the pipe form 102 passes by an inspection station 128 where the helical seam is inspected. The inspection may be implemented by numerous methods, including x-ray, heat monitoring, or visual inspection.

Next, the pipe form 102 enters the pipe puller 118. In an embodiment, per the schematic end elevation view of FIG. 5, the pipe puller 118 may include a plurality of wide rubber wheels 119 arranged to capture the outside diameter of the pipe form 102 and act to pull the pipe form 102 out of the forming mill 112 by driven rotation of each wheel 119 about a respective axis that may be defined by a drive shaft 121. The wheels 119 are angled relative to the longitudinal axis of the pipe to align with the helix angle of the seam so that the wheels simultaneously work to rotate the pipe form and pull the pipe form consistent with the angular rotation of the pipe form as it exits the forming mill. The angle of the wheels may be adjustable to accommodate different pipe sizes an helix angles. The drive for the wheels may be a single, variable speed motor 123 that is linked by chains or some other drive to each drive shaft 121. Alternatively, each drive shaft may have its own drive motor. During this process, a pipe stabilizer unit 120 supports the pipe form 102 as it is pulled out of the forming mill 112. Once the desired length of pipe is achieved, the pipe form 102 is cutoff by the downstream cutoff unit 130, which may, for example, be a saw mechanism or plasma cutter. After the pipe form 102 is cutoff, the pipe is fully removed from the work platform and laid down.

Referring now to FIG. 2, a top plan view of is shown. Generally, the profiling mill 110 may be positioned at different angles relative to the forming mill 112. For example, FIG. 2 shows profiling mill 110a in a first position relative to the forming 112 and profiling mill 110b in a second position relative to the forming 112. These different angular positions result in a different degree of helix in the strip when wound and thus different diameters, with mill position/angle 110a resulting in a larger diameter pipe than mill position/angle 110b. Pipe form 102 diameter is changed by varying the angle of the profiling mill 110 relative to the forming mill 112. In another embodiment, the mobile platform mill 100 may include an air compressor 202 to provide compressed air to the pipe producing operations, as well as a hydraulic pump 203 (FIG. 1).

As shown in FIG. 1, in one embodiment the decoiler and forming mill may relocated from the pipe forming location reflected by 108 and 110 to a sheet production station reflected by 108′ and 110′. In the sheet production location the arrangement can feed out flat or profiled metal sheet from the work platform along a feed out axis or direction 125. The mobile pipe pull vehicle, winch and cone mentioned below can be used to pull the sheet away from the platform as it is produced.

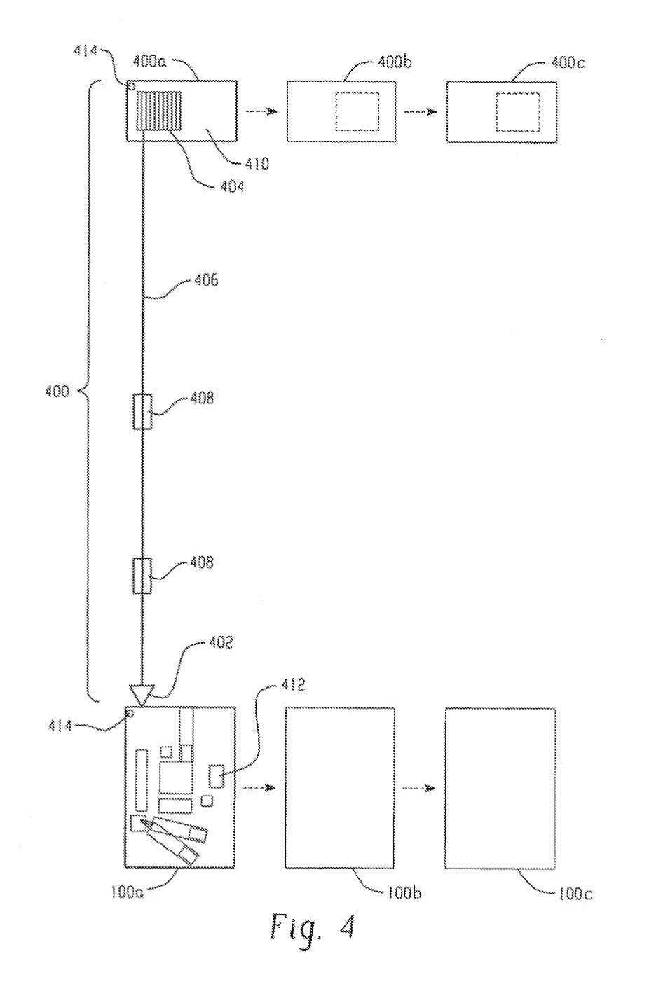

Referring now to FIG. 3, a side elevation view of an exemplary mobile platform mill 100 is shown. In an embodiment, the driver unit includes a leveling system to ensure the work platform is always level to sustain a repeatable pipe producing process. The leveling system 308 includes a plurality of powered actuators 304 that act to raise or lower portions of the work platform 134, and a plurality of leveling sensors 302 providing feedback control. In another embodiment, leveling system 308 could be a mechanical system provided to allow operators to manually level the work platform 134.

In an embodiment, the mobile platform mill 100 includes a railing 126 along the side edge portions of the work platform 134. In another embodiment, the mobile platform mill 100 includes a tent structure 306 to cover and enclose the mobile platform mill 100 and the mill operators to facilitate maintenance of lower temperatures in the summer and warmer temperatures in the winter. In this regard, referring back to FIG. 2, one or more heater units 204 may be provided on the work platform 134 in the enclosure. The mobile platform may also include on or more stair sections 141 (FIG. 1) for enabling user access to the platform. The stair sections would typically be removed (or at least raised) during movement of the work platform about a construction site.

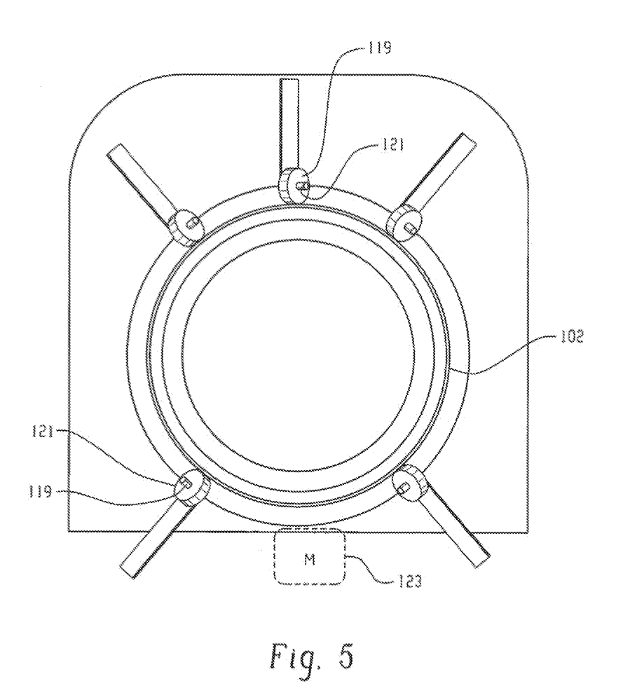

Referring now to the schematic plan view of FIG. 4, an exemplary mobile platform mill 100 used in conjunction with a mobile pipe pull system 400 is shown. In an embodiment, the pipe pull system 400 includes a pipe cone apparatus 402, a pipe pull winch 404, a cable 406, and a plurality of pipe roller sleds 408. The pipe cone apparatus 402, attaches to one end of the cable 406, and connects to the exiting end of the pipe form 102. The other end of the cable 406 is attached to the pipe pull winch 404. The pipe pull winch coils the cable 406 which acts to assist with pulling the pipe form 102 out of the mobile platform mill 100. A plurality of roller sleds 408 are placed between the pipe pull winch 404 and the mobile platform mill 100 in order to support the pipe from 102 as it exits the mobile platform mill 100. In an embodiment the pipe pull winch 404 may be mounted on a vehicle 410. In an embodiment, the combination of the mobile platform mill 100 and the pipe pull system 400 includes a laser sighting and alignment apparatus 414 adapted to assure the desired and appropriate alignment of the mobile platform mill 100 and the pipe pull winch 404 prior to pipe production.

In an embodiment, a method for producing pipe at a construction site includes: transporting a plurality of platform segments 104 to the construction site. The platform segments are assembled to form work platform 134. After assembling the work platform 134 a plurality of modules are mounted to the work platform 134 (e.g., driver tracks 124, decoiler unit 108, profiling mill 110, forming mill 112, joiner unit 114, generator 116, controller 137, pipe puller 118, pipe stabilizer unit 120, inspection station 128, air compressor 202, hydraulic pump, cutoff unit 130 etc.) to enable pipe production on the platform 134. The mobile platform mill 100 is then moved into the desired position 100a using the driver unit to operate the tracks 124. In an embodiment, the driver unit may also include a global positioning system (GPS) 412 adapted to assist in moving the mobile platform mill 100 from point to point with precision. In another embodiment, the driver unit may include a laser sighting and alignment apparatus 414 adapted to assist in moving the mobile platform mill 100 from point to point, and aligning the mobile platform mill 100 with the pipe pull winch 404. After the mobile platform mill 100 is in the desired position, the work platform 134 is leveled using the leveling system 308. After leveling is complete, the mobile platform mill 100 is ready to produce pipe forms 102. When producing long runs of pipe forms 102, the pipe pull system 400 may be utilized. In an embodiment, the pipe pull system 400 is spaced apart from the mobile platform mill 100 to pull the pipe form 102 from the mobile platform mill 100 along a pipe laying path.

After the pipe form 102 is laid at a first desired location, the mobile platform mill 100 is then moved to a second desired position. FIG. 4 shows mobile platform mill 100 moving from a first desired location 100a, to a second desired location 100b, and to a third desired location 100c. Advantageously, the platform arrangement and integrated drive system for movement of the same enables the mill to be moved from one location to another without break down of the mill before movement and then set up of the mill at the new location, saving significant time and expense. When using the pipe pulling system 400, the pipe pulling system 400 moves into alignment with the mobile platform mill 100 at each desired location. FIG. 4 shows the pipe pulling system 400 moving into alignment with the mobile platform mill 100 at first desired location 400a, at a second desired location 400b, and a third desired location at 400c.

While various embodiments of the present disclosure have been described above, it should be understood that they have been presented by the way of example only, and not limitation. It will be understood by those skilled in the art that various changes in form and details may be made therein without departing from the spirit and scope of the disclosure as defined. Thus, the breadth and scope of the present disclosure should not be limited by any of the above-described exemplary embodiments.

What is claimed is:

1. A mobile platform mill for on-site production of pipe, comprising:
a plurality of platform segments coupled together to form a work platform;
a driver unit supporting the work platform above the ground and adapted to move the work platform about a construction site;
a pipe production system mounted on the work platform and including:
a decoiler unit for holding and decoiling a rolled steel sheet;
a profiling mill for forming said steel sheet into a desired profile;
a forming mill for helically coiling said profiled steel sheet into a pipe form;
a joiner unit for joining a helical seam of said pipe form;
a generator to provide power to said mobile platform mill; and
a controller for controlling operations of said mobile platform mill.

2. The mobile platform mill of claim 1, further comprising:
a leveling system on the work platform for leveling said work platform.

3. The mobile platform mill of claim 1, further comprising:
a pipe pull arrangement that pulls said pipe form from said forming mill.

4. The mobile platform mill of claim 3, wherein said pipe pull arrangement is comprised of a pull drive motor and a plurality of spaced apart driven wheels for engaging and driving an outer surface of said pipe as it is produced.

5. The mobile platform mill of claim 4 wherein the driven wheels are angled relative to a longitudinal axis of the pipe form to align with a helix angle of the pipe form.

6. The mobile platform mill of claim 2, wherein said driver unit further comprises a series of drive tracks.

7. The mobile platform mill of claim 6 wherein said driver unit further comprises at least one of (i) a global positioning system (GPS) adapted to assist in positioning the work platform for pipe production or (ii) a laser sighting system.

8. The mobile platform mill of claim 2, wherein said leveling system comprises a plurality of powered actuators with leveling sensors providing feedback control.

9. The mobile platform mill of claim 1, wherein said profiling mill is movable between a first station on said work platform for feeding profiled steel sheet to said forming mill and a second station for feeding profiled steel sheet off of the work platform.

10. The mobile platform mill of claim 1, wherein said joiner unit is a laser welding apparatus.

11. The mobile platform mill of claim 1 in combination with a pipe pull system comprising:
a pipe pull cone apparatus for connecting to the exiting end of said pipe form;
a pipe pull winch; and
a cable for connecting said pipe pull cone to said pipe pull winch.

12. The mobile platform mill of claim 11, wherein said pipe pull winch is mounted on a vehicle that is movable separate from the platform mill.

13. The mobile platform mill of claim 11, wherein said combination of said mobile platform mill and said pipe pull system further comprises a laser sighting and alignment apparatus adapted to assure the desired and appropriate alignment of said mobile platform mill and said pipe pull winch prior to pipe production.

14. The mobile platform mill of claim 1, further comprising a railing along side edge portions of the work platform, and a tent structure to substantially enclose a working space above the work platform.

15. The mobile platform mill of claim 14, further comprising one or more heater units.

16. The mobile platform mill of claim 1, wherein said pipe production system further comprises:
an inspection station for inspecting said joined helical seam;
a compressed air system to provide air pressure to said mobile platform mill; and
a cutoff unit for cutting of said pipe form to a desired length.

17. The mobile platform mill of claim 1 wherein each of the platform segments is sized for transport on standard size truck trailer.

18. A method for on-site production of pipe using a mobile platform mill comprising:
transporting a plurality of platform segments to a construction site;
assembling said platform segments at said construction site to forma work platform;
transporting a plurality of modules to said construction site comprising:
a driver unit supporting said work platform above the ground and adapted to move said work platform about the construction site;
a decoiler unit for holding and decoiling a rolled steel sheet;
a profiling mill for forming said steel sheet into a desired profile;
a forming mill for helically coiling said profiled steel sheet into a pipe form;
a joiner unit for joining a helical seam of said pipe form;
a generator to provide power to said mobile platform mill;
a controller for controlling operations of said mobile platform mill; and
mounting said modules on said work platform.

19. The method for on-site production of pipe of claim 18, wherein each of the platform segments is transported on a standard size truck trailer.

20. The method for on-site production of pipe of claim 18, wherein the plurality of modules further comprises:
a leveling system for leveling said work platform.

21. The method for on-site production of pipe of claim 20, wherein said leveling system comprises a plurality of powered actuators with leveling sensors providing feedback control.

22. The method for on-site production of pipe of claim 18, wherein the plurality of modules further comprises:
a pipe puller that pulls said pipe form from said forming mill; and
a pipe stabilizer unit for supporting said pipe form as it is pulled out of said forming mill.

23. The method for on-site production of pipe of claim 18, wherein said driver unit further comprises at least one of (i) a global positioning system (GPS) adapted to assist in positioning the work platform for pipe production or (ii) a laser sighting system.

24. The method for on-site production of pipe of claim 18, further comprising utilizing a mobile pipe pull apparatus that is spaced apart from the mobile platform mill and movable separate from the mobile platform mill to pull pipe from the mobile platform mill along a pipe laying path.

25. The method of claim 24 wherein:
the mobile pipe pull apparatus comprises:
a pipe pull cone apparatus for connecting to the exiting end of said pipe form;
a pipe pull winch; and
a cable for connecting said pipe pull cone to said pipe pull winch.

26. The method for on-site production of pipe of claim 24, further comprising aligning said mobile platform mill and said mobile pipe pull apparatus along the pipe laying path prior to pipe production.

27. The method for on-site production of pipe of claim 18, further comprising leveling the mobile platform mill.

28. The method for-on-site production of pipe of claim 18, further comprising moving the mobile platform mill to a desired position.

29. The method for on-site production of pipe of claim 18, further comprising cutting said pipe form to a desired length that is at least 100 feet.

30. The method for on-site production of pipe of claim 18, further comprising enclosing the mobile platform mill with a composite tent structure.

31. The method for on-site production of pipe of claim 30, further comprising heating said enclosure with one or more heater units.

32. A method for on-site production of pipe using a mobile platform mill and a mobile pipe puller comprising:
utilizing a mobile platform mill that includes a platform formed of a plurality of platform segments assembled on-site and supporting a corrugated metal pipe production system that includes a profiling mill for forming said steel sheet into a desired profile, a forming mill for helically coiling said profiled steel sheet into a pipe form, and a joiner unit for joining a helical seam of said pipe form, the mobile platform mill further comprising an on-board platform drive system for moving the platform around the job site independent of any transport truck or vehicle;
utilizing a mobile pipe pull apparatus that is separate from the mobile platform mill and includes a pipe pull cable and winch;
positioning the mobile platform mill toward a first end of a defined pipe laying path by operation of the on-board platform drive system;
positioning the mobile pipe pull apparatus toward a second end of the defined pipe laying path;
operating the pipe production system of the mobile platform mill to produce corrugated metal pipe;
operatively coupling the pipe pull cable to the corrugated metal pipe;
operating the pipe pull winch to pull pipe along the pipe laying path as it is produced.

33. The method of claim 32 wherein the step of positioning the mobile platform mill includes one or both of (i) utilizing an on-board GPS system of the mobile platform mill to define an end location of the mobile platform mill or (ii) utilizing a laser sighting system to define an end location of the mobile platform mill.

34. The method of claim 32, further comprising:
operating the pipe production system to produce a continuous pipe structure that extends a full length of the pipe laying path;
cutting the pipe using a cutoff unit mounted on the platform;
positioning the mobile platform mill toward a first end of a second defined pipe laying path by operation of the on-board platform drive system;
positioning the mobile pipe pull apparatus toward a second end of the second defined pipe laying path;
operating the pipe production system of the mobile platform mill to produce corrugated metal pipe;
operatively coupling the pipe pull cable to the corrugated metal pipe;
operating the pipe pull winch to pull pipe along the second pipe laying path as it is produced.
